(19) United States
(12) Patent Application Publication
(10) Pub. No.: US 2025/0115092 A1
(43) Pub. Date: Apr. 10, 2025

(54) APPARATUS FOR PREDICTING QUANTITY AND DIRECTION OF SOLAR RADIATION

(71) Applicants: Hyundai Motor Company, Seoul (KR); Kia Corporation, Seoul (KR)

(72) Inventors: Sang Shin LEE, Suwon-si (KR); Myung Hun KANG, Gwangmyeong-si (KR)

(21) Appl. No.: 18/741,060

(22) Filed: Jun. 12, 2024

(30) Foreign Application Priority Data
Oct. 6, 2023 (KR) 10-2023-0133256

(51) Int. Cl. B60H 1/00; B60S 1/02; G01J 1/38; G01K 1/02

(52) U.S. Cl. CPC B60H 1/0075; B60H 1/0073; B60H 1/00742; B60H 1/00785; B60S 1/023; G01J 1/38; G01K 1/026

(57) ABSTRACT

An apparatus for predicting a quantity and direction of solar radiation includes a sensor unit configured to measure an external temperature of a vehicle, an interior temperature of the vehicle, and a temperature of a windshield glass of the vehicle, a camera unit configured to capture driving environments outside the vehicle and a state of a driver, and a controller configured to predict the quantity of solar radiation based on the sensor unit, and to predict the direction of solar radiation through the camera unit.

### CROSS-REFERENCE TO RELATED APPLICATION

This application claims under 35 U.S.C. § 119 (a) the benefit of priority to Korean Patent Application No. 10-2023-0133256, filed on Oct. 6, 2023, the entire contents of which are incorporated herein by reference.

### TECHNICAL FIELD

The present disclosure relates to an apparatus for predicting a quantity and direction of solar radiation. More particularly, it relates to an apparatus which predicts a quantity and direction of solar radiation in a vehicle without a separate element configured to sense the quantity of solar radiation, and performs air-conditioning of the vehicle based on the predicted quantity and direction of solar radiation.

### BACKGROUND

An air conditioning system of a vehicle may be operated depending on environmental conditions of the inside and outside of the vehicle and control conditions by a user, and the air conditioning system controls an indoor environment of the vehicle. Because environments of the inside and outside of the vehicle are constantly changing, a control system, such as an automatic temperature controller (ATC) configured to automatically control the temperature of the interior of the vehicle depending on change in environments or control conditions, is installed together with the air conditioning system.

That is, such a conventional air conditioning control structure for vehicles is configured such that the control system controls the air conditioning system based on signal inputs from various sensors and a temperature set by the user.

Therefore, the control system controls the air conditioning system by setting a designated target temperature depending on the environmental conditions, such as an outdoor air temperature, an indoor air temperature, a quantity of solar radiation, and the control conditions, such as a set temperature. The control system may create a pleasant indoor temperature by controlling an outlet temperature of an evaporator or an intake door and an air volume in the air conditioning system. Particularly, the control system sets the target temperature depending on the environmental conditions and the control conditions so as to control the outlet temperature of the evaporator, and controls the capacity of a compressor or the opening degree of a throttle valve so that the outlet temperature of the evaporator reaches the set target temperature.

Here, main data transmitted to the control system includes a quantity of solar radiation, and the quantity of solar radiation is sensed by a sun sensor, such as a photodiode or the like, mounted on an in-panel of the vehicle and is transmitted to the control system. Such a sun sensor senses the quantity of solar radiation using current of the diode increased or decreased depending on the intensity of sunlight, and the control system controls the air conditioning system depending on the quantity of solar radiation sensed by the sun sensor.

Sun sensors are divided into a single-type sun sensor configured to sense a quantity of solar radiation applied to a driver's seat, and a dual-type sun sensor configured to sense quantities of solar radiation applied to both a driver's seat and a front passenger seat. Here, the control system may sense quantities of solar radiation applied to a driver's seat and a front passenger seat using signals transmitted from a dual automatic temperature controller (DATC) using such a dual-type sun sensor, and may perform compensatory control of the air conditioning system so as to perform independent left and right air-conditioning with respect to the driver's seat and the front passenger seat.

However, vehicles including a sensor configured to determine autonomous driving and external conditions of the vehicles and a large number of sensors configured to measure internal and external temperatures of the vehicles are on the market. Further, vehicles including sensor elements configured to estimate a quantity of solar radiation and a direction of solar radiation without a separate sun sensor are on the market, and these vehicles have a drawback in that the sensor elements perform overlapping functions.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide an apparatus for predicting a quantity of solar radiation by determining quantities of heat exchanged between indoor and outdoor air temperatures of a vehicle and a glass temperature.

It is another object of the present disclosure to provide an apparatus for estimating a positional relationship of the sun with respect to a vehicle through a camera unit configured to photograph the outside or the inside of the vehicle.

In one aspect, the present disclosure provides an apparatus for predicting a quantity and direction of solar radiation, including a sensor unit configured to measure an external temperature of a vehicle, an interior temperature of the vehicle, and a temperature of a windshield glass of the vehicle, a camera unit configured to capture driving environments outside the vehicle and a state of a driver, and a controller configured to predict the quantity of solar radiation based on the sensor unit, and to predict the direction of solar radiation through the camera unit.

In some implementations, the sensor unit may include an outdoor air temperature sensor configured to measure the external temperature of the vehicle, an in-car sensor configured to measure the interior temperature of the vehicle, and an auto defog sensor configured to measure the temperature of the windshield glass of the vehicle.

In some implementations, the controller may estimate the quantity of solar radiation as a difference acquired by subtracting a quantity of heat exchanged between the windshield glass and an interior of the vehicle, and a quantity of heat exchanged between the windshield glass and an outside of the vehicle from a quantity of heat of the windshield glass obtained based on the auto defog sensor.

In some implementations, the controller may determine thermal energy of the windshield glass by applying the temperature of the windshield glass measured by the auto defog sensor to a temperature function.

In some implementations, the camera unit may include an external camera configured to capture the driving environments outside the vehicle, and an internal camera configured to determine a state of a passenger.

In some implementations, the internal camera may be configured to determine a face state of the passenger.

In some implementations, the controller may estimate the direction of solar radiation based on shadows captured by the external camera or the internal camera.

In some implementations, data measured by the external camera or the internal camera may be stored in the controller through a CNN learning model.

In some implementations, the controller may drive an independent air conditioning system in an interior of the vehicle so as to correspond to the predicted quantity and direction of solar radiation.

In some implementations, when the quantity of solar radiation is equal to or greater than a set value, the controller may control the independent air conditioning system to increase a quantity of air conditioning toward a seat facing the direction of solar radiation, compared to a quantity of air conditioning toward a seat away from the direction of solar radiation.

In another aspect, the present disclosure provides an apparatus for predicting a quantity and direction of solar radiation, including a sensor unit configured to measure an external temperature of a vehicle, an interior temperature of the vehicle, and a temperature of a windshield glass of the vehicle, a camera unit configured to capture driving environments outside the vehicle and a state of a driver, and a controller configured to calculate a quantity of heat of the windshield glass, a quantity of heat exchanged between the windshield glass and an interior of the vehicle, and a quantity of heat exchanged between the windshield glass and an outside of the vehicle based on the sensor unit, to predict the quantity of solar radiation based on the calculated quantities of heat, and to predict the direction of solar radiation through the camera unit.

In some implementations, the sensor unit may include an outdoor air temperature sensor configured to measure the external temperature of the vehicle, an in-car sensor configured to measure the interior temperature of the vehicle, and an auto defog sensor configured to measure the temperature of the windshield glass of the vehicle.

In some implementations, the controller may estimate the quantity of solar radiation as a difference acquired by subtracting the quantity of heat exchanged between the windshield glass and the interior of the vehicle, and the quantity of heat exchanged between the windshield glass and the outside of the vehicle from the quantity of heat of the windshield glass obtained based on the auto defog sensor.

In some implementations, the controller may determine thermal energy of the windshield glass by applying the temperature of the windshield glass measured by the auto defog sensor to a temperature function.

In some implementations, the camera unit may include an external camera configured to capture the driving environments outside the vehicle, and an internal camera configured to determine a state of a passenger.

In some implementations, the internal camera may be configured to determine a face state of the passenger.

In some implementations, the controller may estimate the direction of solar radiation based on shadows captured the external camera or the internal camera.

In some implementations, data measured by the external camera or the internal camera may be stored in the controller through a CNN learning model.

In some implementations, the controller may drive an independent air conditioning system in an interior of the vehicle so as to correspond to the predicted quantity and direction of solar radiation.

In some implementations, when the quantity of solar radiation is equal to or greater than a set value, the controller may control the independent air conditioning system to increase a quantity of air conditioning toward a seat facing the direction of solar radiation, compared to a quantity of air conditioning toward a seat away from the direction of solar radiation.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure.

FIG. 1 is a view showing an example of a sensor unit configured to estimate a quantity of solar radiation.

FIG. 2 is a block diagram showing an example of coupling relations among elements of an apparatus for predicting a quantity and direction of solar radiation.

FIG. 3 is a view showing an example of a processor of a controller configured to estimate the direction of solar radiation using an internal camera.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various implementations of the present disclosure, examples of which are illustrated in the accompanying drawings and described below. The present disclosure is not limited to the following implementations, and the implementations may be implemented in various different forms. The implementations are provided to make the description of the present disclosure thorough and to fully convey the scope of the present disclosure to those skilled in the art.

Further, in the following description of the implementations, it will be understood that the suffixes “sensor,” “unit,” “device,” etc. indicate units for processing at least one function or operation, and may be implemented as software, hardware, or a combination of software and hardware.

The terminology used herein is for the purpose of describing particular implementations only and is not intended to be limiting. As used herein, singular forms may be intended to include plural forms as well, unless the context clearly indicates otherwise.

In some implementations, a controller 10 may be implemented as including a memory which stores data regarding an algorithm configured to control operations of various elements disposed in a vehicle or a program configured to reproduce the algorithm, and a processor which executes the above-described operations using the data stored in the memory. Here, the memory and the processor may be implemented as individual chips. Otherwise, the memory and the processor may be implemented as a single chip. For example, the controller 10 may include at least one of an electronic controller (ECU), a central processing unit (CPU), a microprocessor unit (MPU), a microcontroller unit (MCU), an application processor (AP), or any arbitrary processors which are well known to those skilled in the art to which the present disclosure pertains. Further, the controller 10 may include a combination of software and hardware which may perform calculation in at least one application or program configured to execute methods according to the implementations of the present disclosure.

The controller 10 may be an electronic controller (ECU) belonging to an ECU level, which is a device configured to integrally control a plurality of electrical devices used in a vehicle. For example, the controller 10 may control processors belonging to a processor level and controllers belonging to a controller level. The controller 10 may receive sensing data from the processors, may generate control commands configured to control the controllers so as to suit circumferences, and may transmit the control commands to the controllers. Although the specification describes the controller 10 belonging to the ECU level which is a higher level than the processor level for the sake of convenience of explanation, one of the processors belonging to the processor level may serve as the ECU, or two processors may be combined to serve as the ECU.

Hereinafter, reference will be made in detail to the implementations of the present disclosure, examples of which are illustrated in the accompanying drawings and described below. Wherever possible, the same reference numbers will be used throughout the drawings to refer to the same or like parts, and a redundant description thereof will be omitted.

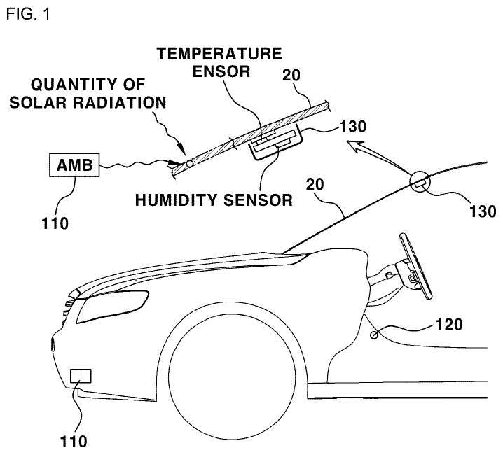

FIG. 1 shows an example configuration of an apparatus for predicting a quantity and direction of solar radiation.

In some implementations, the controller 10 estimates the quantity of solar radiation based on an external temperature of the vehicle, an interior temperature of the vehicle and a temperature of a windshield glass 20 measured by a sensor unit 100. Further, the controller 10 is configured to predict the direction of solar radiation based on driving environments outside the vehicle or a driver's state measured by a camera unit 200.

The sensor unit 100 includes an outdoor air temperature sensor 110 configured to measure the external temperature of the vehicle, an in-car sensor 120 configured to measure the interior temperature of the vehicle, and an auto defog sensor 130 configured to measure the temperature of the windshield glass 20.

In some implementations, the outdoor air temperature sensor 110 is located outside the vehicle, and measures the external temperature during driving of the vehicle. Two kinds of sensors, i.e., an ambient (AMB) sensor configured to measure only a temperature and an air quality sensor (AQS) configured to measure a temperature and to perform automatic conversion between indoor air and outdoor air in an air conditioner, may be used as the outdoor air temperature sensor 110.

Further, in some implementations, the in-car sensor 120 is a sensor configured to sense the temperature of indoor air within the vehicle, and an automatic temperature controller controls the air conditioner using the temperature sensed by the in-car sensor 120 and discharges proper air to the interior of the vehicle, so that the interior temperature of the vehicle reaches a target temperature.

The auto defog sensor 130 predicts and/or detects fog formed on the surface of the windshield glass 20, and automatically prevents and removes the fog in conjunction with a heating system and/or an air conditioning system. The auto defog sensor 130 is employed on the surface of the windshield glass 20 so as to allow a driver to drive the vehicle safely.

The auto defog sensor 130 may include a temperature sensor and a relative humidity sensor provided on the surface of the windshield glass 20. Further, in order to calculate a comparatively accurate dew point temperature, the relative humidity sensor is provided adjacent to the in-car sensor 120, and thereby, the auto defog sensor 130 measures a humidity and a temperature at the same position as the in-car sensor 120.

Further, the temperature sensor located in the auto defog sensor 130 is located to come into contact with the surface of the windshield glass 20, or to be spaced apart from the surface of the windshield glass 20 by a designated distance. Therefore, the auto defog sensor 130 may measure the current temperature of the windshield glass 20 of the vehicle, and may transmit the measured temperature to the controller 10.

The controller 10 receives the current measured values of the external temperature of the vehicle, the interior temperature of the vehicle and the temperature of the windshield glass 20 from the outdoor air temperature sensor 110, the in-car sensor 120 and the auto defog sensor 130. Further, the controller 10 may calculate a current quantity of heat of the windshield glass 20, a quantity of heat exchanged between the windshield glass 20 and the outside of the vehicle, and a quantity of heat exchanged between the windshield glass 20 and the interior of the vehicle in consideration of the respective received temperature conditions. In addition, the controller 10 determines thermal energy of the windshield glass 20 by applying the temperature of the windshield glass 20 measured in calculation of the current quantity of heat of the windshield glass 20 to a temperature function. The temperature function is configured to be stored by the controller 10.

In some implementations, thermal energy applied to the windshield glass 20 may be calculated as the total quantity of heat substantially transmitted to the windshield glass 20, and the sum of a quantity of heat applied to the windshield glass 20 by the quantity of solar radiation, the quantity of heat exchanged between the windshield glass 20 and the interior of the vehicle, and the quantity of heat exchanged between the windshield glass 20 and the outside of the vehicle may be calculated as the current quantity of heat of the windshield glass 20. Further, the controller 10 may calculate the quantities of heat exchanged using specific heat of air depending on temperature, specific heat of the windshield glass 20, and surface area data of the windshield glass 20, which are stored in the controller 10.

Therefore, the quantity of solar radiation may be calculated as a difference acquired by subtracting the quantity of heat exchanged between the windshield glass 20 and the outside of the vehicle and the quantity of heat exchanged between the windshield glass 20 and the interior of the vehicle from the quantity of heat of the windshield glass 20. That is, the controller 10 may calculate the quantity of solar radiation through the following equation based on temperature information measured by the outdoor air temperature sensor 110, the in-car sensor 120 and the auto defog sensor 130.

Q quantity of solar radiation=Q glass−Q heat exchanged between outdoor air temperature and glass−Q heat exchanged between indoor air temperature and glass

As described above, the controller 10 may estimate the quantity of solar radiation flowing into the vehicle based on the temperature conditions of the outside and the interior of the vehicle and the temperature conditions of the windshield glass 20 through the outdoor air temperature sensor 110, the in-car sensor 120 and the auto defog sensor 130.

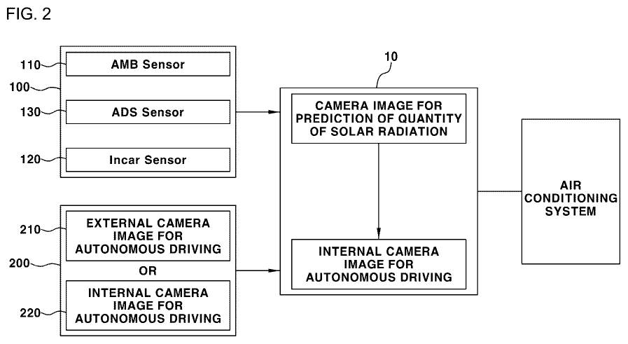

Further, as shown in FIG. 2, the controller 10 is configured to calculate the direction of solar radiation through a learning model of the camera unit 200 simultaneously with calculation of the quantity of solar radiation through the sensor unit 100 including the outdoor air temperature sensor 110, the in-car sensor 120 and the auto defog sensor 130.

In some implementations, the camera unit 200 may include an external camera 210 which may measure the driving environments outside the vehicle, and an internal camera 220 which may capture a passenger seated in the vehicle.

The external camera 210 according to the present disclosure recognizes the form of a target object through visible light and provides information, and may thus receive driving environment information of the vehicle, such as vehicles, traffic lights, signs, etc. ahead of the vehicle. Further, the external camera 210 according to the present disclosure may capture the shadow shape of the target object ahead of the vehicle, and may transmit captured shadow shape data to the controller 10.

Further, the internal camera 220 according to the present disclosure is located to capture a passenger seated on each of seats. Further, the internal camera 220 may capture the face of a passenger seated in the driver's seat.

The internal camera 220 may capture the shadows on the face of the passenger seated in the driver's seat, and may transmit captured data to the controller 10.

The controller 10 is configured to calculate the direction of solar radiation based on at least one of the data transmitted from the external camera 210 or the internal camera 220. Further, the controller 10 is configured to be trained with a lot of data received through the external camera 210 or the internal camera 220 through a convolutional neural network (CNN) learning model, and to predict the direction of solar radiation based on current measured data.

The CNN learning model of the controller 10 may include a prior learning performer, a feature value extractor, a feature group generator, a group accuracy calculator, a relearning target group selector, and a relearning performer.

The prior learning performer may input a plurality of training data to one convolutional neural network so as to train a deep learning model, i.e., the CNN learning model.

In some implementations, the training data may use image data, but is not limited thereto and may use data having various formats, sizes and kinds, and such various data may be converted into a standardized format and specification through preprocessing so as to perform training.

In some implementations, the prior learning performer may make up one data set from the plurality of training data, and may perform training of the deep learning model by inputting the data set to the convolutional neural network by a predetermined number of times of prior deep learning.

The feature group generator may generate a plurality of feature groups based on a plurality of extracted feature values. In some implementations, the feature group generator may normalize the plurality of extracted feature values, and may generate the plurality of feature groups by dividing the normalized extracted feature values depending on a predetermined range.

The group accuracy calculator may calculate accuracies of the respective generated feature groups. In some implementations, the group accuracy calculator may calculate deep learning calculation result accuracies of the training data respectively matching with the plurality of feature values included in each of the feature groups, and may calculate accuracy of each of the feature groups by calculating the average of the sum of the calculated deep learning calculation result accuracies.

The group accuracy calculator may calculate accuracy of each of the feature groups by calculating the average of the sum of accuracies of the training data matching with the feature values included in each of the feature groups using the calculated accuracies of the training data.

The relearning target group selector and the relearning performer calculate accuracies of newly measured data through the same process, in addition to the training data, the accuracies of which were calculated.

That is, the controller 10 may analyze accuracies of current data measured by the camera unit 200 based on the CNN learning model, and may predict the direction of solar radiation. In some examples, the controller 10 may predict the direction of solar radiation based on shadow shapes of vehicles or obstacles located in the driving environments of the vehicle, captured by the external camera 210. Further, the controller 10 may predict the direction of solar radiation based on shadows formed on the face of the passenger seated in the driver's seat, captured by the internal camera 220.

As such, the controller may predict the quantity of solar radiation applied from the sun to the vehicle based on measured temperature conditions, and may predict the direction of solar radiation based images captured by the camera unit 200, simultaneously.

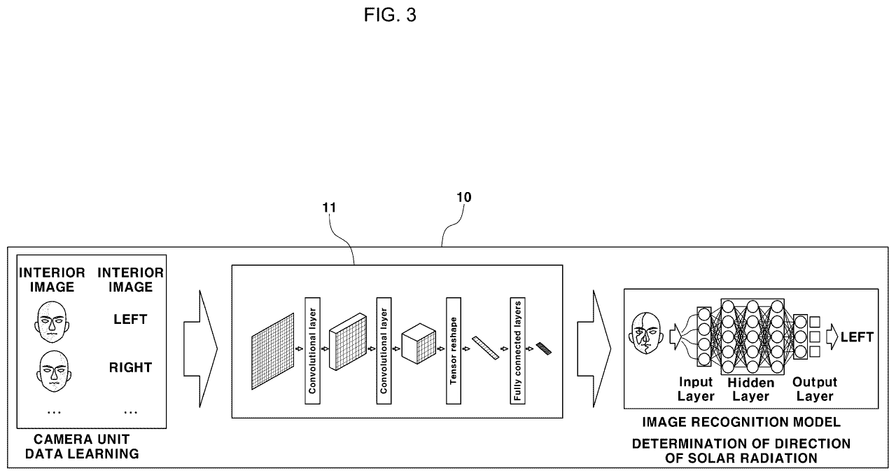

FIG. 3 shows an example of processing of images captured by the internal camera 220 to predict the direction of solar radiation.

The internal camera 220 may capture a face area of the passenger seated in the driver's seat. The controller 10 may determine degrees of left and right shadows in a captured face area image. For example, the controller 10 may determine and calculate the shapes, lengths and angles of the shadows. In some examples, the controller 10 may be configured to store areas of the shadows, and to perform training of a CNN learning module 11 with the stored captured images. The controller 10 may analyze accuracies of data based on calculated data groups, and may predict the direction of solar radiation depending on the current position of the sun.

Further, the controller 10 is configured to control the air conditioning system in the state in which the quantity of solar radiation and the direction of solar radiation are estimated.

In some implementations, a control mode selection button configured to select dual mode control to independently control two air conditioning areas, i.e., an area corresponding to the driver's seat and an area corresponding to the front passenger seat, or single mode control to integrally control one air conditioning area, a temperature set button configured to independently set target indoor temperatures of the two air conditioning areas to different temperatures when the dual mode control is selected, and an automatic mode selection button configured to select an automatic temperature control mode or a manual temperature control mode may be provided on the controller 10.

The controller 10 controls the air conditioning system based on the quantity and direction of solar radiation calculated when the automatic temperature control mode of the air conditioning system is selected through the automatic mode selection button. Further, the controller 10 increases the driving amount of the air conditioning system, upon determining that the quantity of solar radiation is equal to or greater than a set value.

Further, the controller 10 increases a quantity of independent air conditioning toward one side of the left and right sides of the vehicle closer to the sun based on the estimated direction of solar radiation. In some examples, the controller 10 may increase the amount of air conditioning toward the first row and the second row of the side of the vehicle closer to the sun, and may lower a temperature of the air conditioning toward the first row and the second row of the side of the vehicle closer to the sun.

As described above, the controller 10 according to the present disclosure is configured to calculate the quantity and direction of solar radiation based on the sensor unit 100 and the camera unit 200 in the vehicle without a sun sensor, and to control the air conditioning system based on the calculated quantity and direction of solar radiation.

As is apparent from the above description, the present disclosure provides the following effects through the above-described configuration and connection and usage relations.

An apparatus for predicting a quantity and direction of solar radiation according to the present disclosure estimates the quantity of solar radiation applied to a vehicle based on a sensor unit basically mounted in the vehicle, thereby being capable of measuring the quantity of solar radiation without a sun sensor.

Further, the apparatus according to the present disclosure may serve as a sun sensor even in the vehicle without the sun sensor, thereby being capable of reducing vehicle costs.

The disclosure has been described in detail with reference to example implementations thereof. However, it will be appreciated by those skilled in the art that changes may be made in these implementations without departing from the principles and spirit of the disclosure, the scope of which is defined in the appended claims and their equivalents.

What is claimed is:

1. An apparatus, comprising:
one or more sensors configured to measure an external temperature of a vehicle, an interior temperature of the vehicle, and a temperature of a windshield glass of the vehicle;
one or more cameras configured to capture images of a driving environment outside the vehicle and a driver of the vehicle; and
a controller configured to predict a quantity of solar radiation based on measurements of the one or more sensors and to predict a direction of solar radiation based on the images captured by the one or more cameras.

2. The apparatus of claim 1, wherein the one or more sensors comprise:
an outdoor air temperature sensor configured to measure the external temperature of the vehicle;
an in-car sensor configured to measure the interior temperature of the vehicle; and
an auto defog sensor configured to measure the temperature of the windshield glass of the vehicle.

3. The apparatus of claim 2, wherein the controller is configured to:
based on the measurements of the one or more sensors, obtain (i) a first quantity of heat of the windshield glass obtained based on the auto defog sensor, (ii) a second quantity of heat exchanged between the windshield glass and an interior of the vehicle, and (iii) a third quantity of heat exchanged between the windshield glass and an outside of the vehicle;
determine a heat quantity difference by subtracting the second and third quantities of heat from the first quantity of heat; and
predict the quantity of solar radiation based on the heat quantity difference.

4. The apparatus of claim 3, wherein the controller is configured to determine thermal energy of the windshield glass by applying the temperature of the windshield glass measured by the auto defog sensor to a temperature function.

5. The apparatus of claim 1, wherein the one or mere cameras comprise:
an external camera configured to capture the image of the driving environment outside the vehicle; and
an internal camera configured to determine a state of a passenger of the vehicle.

6. The apparatus of claim 5, wherein the internal camera is configured to determine a face state of the passenger.

7. The apparatus of claim 5, wherein the controller is configured to predict the direction of solar radiation based on a shadow captured by the external camera or the internal camera.

8. The apparatus of claim 5, wherein the controller is configured to store data that are measured by the external camera or the internal camera and processed through a convolutional neural network (CNN) learning model.

9. The apparatus of claim 1, wherein the controller is configured to drive an air conditioning system in an interior of the vehicle based on the predicted quantity and direction of solar radiation.

10. The apparatus of claim 9, wherein the controller is configured to:
based on the quantity of solar radiation being greater than or equal to a set value, control the air conditioning system to increase a quantity of air provided toward a seat in the direction of solar radiation relative to a quantity of air provided toward a seat outside the direction of solar radiation.

11. An apparatus, comprising:
one or more sensors configured to measure an external temperature of a vehicle, an interior temperature of the vehicle, and a temperature of a windshield glass of the vehicle;
one or more cameras configured to capture images of a driving environment outside the vehicle and a driver of the vehicle; and
a controller configured to:
based on measurements of the one or more sensors, calculate (i) a first quantity of heat of the windshield glass, (ii) a second quantity of heat exchanged between the windshield glass and an interior of the vehicle, and (iii) a third quantity of heat exchanged between the windshield glass and an outside of the vehicle,
predict a quantity of solar radiation based on the first, second, and third quantities of heat, and
predict a direction of solar radiation based on the images captured by the one or more cameras.

12. The apparatus of claim 11, wherein the one or more sensors comprise:
an outdoor air temperature sensor configured to measure the external temperature of the vehicle;
an in-car sensor configured to measure the interior temperature of the vehicle; and
an auto defog sensor configured to measure the temperature of the windshield glass of the vehicle.

13. The apparatus of claim 12, wherein the controller is configured to:
determine a heat quantity difference by subtracting the second and third quantities of heat from the first quantity of heat; and
predict the quantity of solar radiation based on the heat quantity difference.

14. The apparatus of claim 13, wherein the controller is configured to determine thermal energy of the windshield glass by applying the temperature of the windshield glass measured by the auto defog sensor to a temperature function.

15. The apparatus of claim 11, wherein the one or more cameras comprise:
an external camera configured to capture the image of the driving environment outside the vehicle; and
an internal camera configured to determine a state of a passenger of the vehicle.

16. The apparatus of claim 15, wherein the internal camera is configured to determine a face state of the passenger.

17. The apparatus of claim 15, wherein the controller is configured to predict the direction of solar radiation based on a shadow captured the external camera or the internal camera.

18. The apparatus of claim 15, wherein the controller is configured to store data that are measured by the external camera or the internal camera and processed through a convolutional neural network (CNN0 learning model.

19. The apparatus of claim 11, wherein the controller is configured to drive an air conditioning system in an interior of the vehicle based on the predicted quantity and direction of solar radiation.

20. The apparatus of claim 19, wherein the controller is configured to:
based on the quantity of solar radiation being greater than or equal to a set value, control the air conditioning system to increase a quantity of air provided toward a seat in the direction of solar radiation relative to a quantity of air provided toward a seat outside the direction of solar radiation.
